(19) United States
(12) Patent Application Publication
(10) Pub. No.: US 2020/0078677 A1
(43) Pub. Date: Mar. 12, 2020

(54) SYSTEM AND METHOD FOR MANAGING VIEWABLE SEGMENTS OF COMPUTER APPLICATION CONTENT

(71) Applicant: MZ IP Holdings, LLC, Palo Alto, CA (US)

(72) Inventor: Matt Walsh, San Carlos, CA (US)

(21) Appl. No.: 16/541,642

(22) Filed: Aug. 15, 2019

Related U.S. Application Data
(60) Provisional application No. 62/728,103, filed on Sep. 7, 2018.

(51) Int. Cl. A63F 13/44; A63F 13/77; A63F 13/60

(52) U.S. Cl. CPC A63F 13/44; A63F 2300/5506; A63F 13/60; A63F 13/77

(57) ABSTRACT

In some implementations, a method is provided. The method includes defining a minimum duration of a segment the presenting a portion of content from an application client, the content comprising a plurality of time steps. An interest score is determined for each of the plurality of time steps, the interest score based on events that occurred in a time step. A set of segments is defined, each segment in the set including one or more time steps from the plurality of time steps. One or more of the set of segments are presented to a user.

### CROSS REFERENCE TO RELATED APPLICATIONS

This application claims the benefit of U.S. Provisional Patent Application No. 62/728,103, filed on Sep. 7, 2018, which is hereby incorporated by reference in its entirety.

### BACKGROUND

Many applications that involve viewable content (e.g., mobile games, such as massively multiplayer online (MMO) games, etc.) function by maintaining, modifying and presenting a state. In the example of mobile games, the state may be a game state, which may include, for example, the position of the characters and other game elements within the map environment of the game, events involving certain characters, a current score of the game, and a status of all other elements of the game. Although such games appear to be continuous in nature, the games in fact proceed at discrete time intervals or “time steps.” For example, a game may proceed at time steps of 16 milliseconds each in a game that runs at 60 frames per second. Therefore, it is possible to fully define every aspect of a game by specifying the full state of the game at each of the time steps that occur between the beginning and end of the game.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example of a gameplay network architecture, in accordance with some embodiments of the present disclosure.

FIG. 2 is a diagram illustrating an example progression of a game over each of the time steps the game is comprised of, in accordance with some embodiments of the present disclosure.

FIG. 3A is a diagram of an example of time steps of a game being assigned to segments, in accordance with some embodiments of the present disclosure.

FIG. 38 is a diagram of an example of segments being post processed, in accordance with some embodiments of the present disclosure.

FIG. 4 is a flow diagram of an example method for generating a highlight video, in accordance with some embodiments of the present disclosure.

FIG. 5 is a flow diagram of an example method for generating a set of segments, in accordance with sonic embodiments of the present disclosure.

FIG. 6 is a block diagram of an example computing device, in accordance with some embodiments of the present disclosure.

### DETAILED DESCRIPTION

Many games include a “replay mode” that allows players to access and view games that they (or other players) have previously played. In addition, the course of a game may last for extended periods of time (e.g., hours), which may render watching a replay of an entire game infeasible. However, as with any gaming activity, the course of a mobile game may include a mixture of periods of exciting, climatic and/or pivotal/important events as well as periods of more mundane and inconsequential events. Thus, a player of the game who is utilizing replay mode may not need to watch the entire game, but may desire to watch those portions that are considered interesting (e.g., the exciting, climatic and/or pivotal/important events). Some gaming systems allow a user to manually browse and edit game tiles, which involves parsing out those periods of higher interest and “stitching” such periods together into a “highlight video.” However, in a game that is played over an extended period of time, parsing through the entire game to locate content of interest can be tedious. This problem can be exacerbated if the game is not only long, but involves multiple players and/or a large map in which the events of the game took place (since the user must examine the events over the course of the game in multiple portions of the map),

Aspects of the present disclosure address the above noted and other deficiencies by using processing logic to determine the portions of any appropriate viewable content from an application client that are of the most interest to a user (i.e., the highlights), and compile those portions into a highlight video for display or presentation to one or more users. More specifically, the processing logic may define a minimum length of a segment for presenting a portion of application content, where the application content is comprised of a plurality of time steps. The processing logic may determine an interest score for each of the plurality of time steps. The processing logic may define a set of segments, each segment in the set including one or more time steps from the plurality of time steps and may then display or otherwise present one or more of the set of segments to a user as a highlight video. The processing logic may perform post-processing edits and enhancements that can be used to enhance the identification and/or display of the segments that are most interesting to a viewer. Merely for purposes of illustration and not limitation, the present invention will be discussed in the context of a mobile or online computer game. However, the present invention can be used with any suitable application client for which users may want to view important, noteworthy, or otherwise interesting events occurring or that have occurred during the execution of the application client.

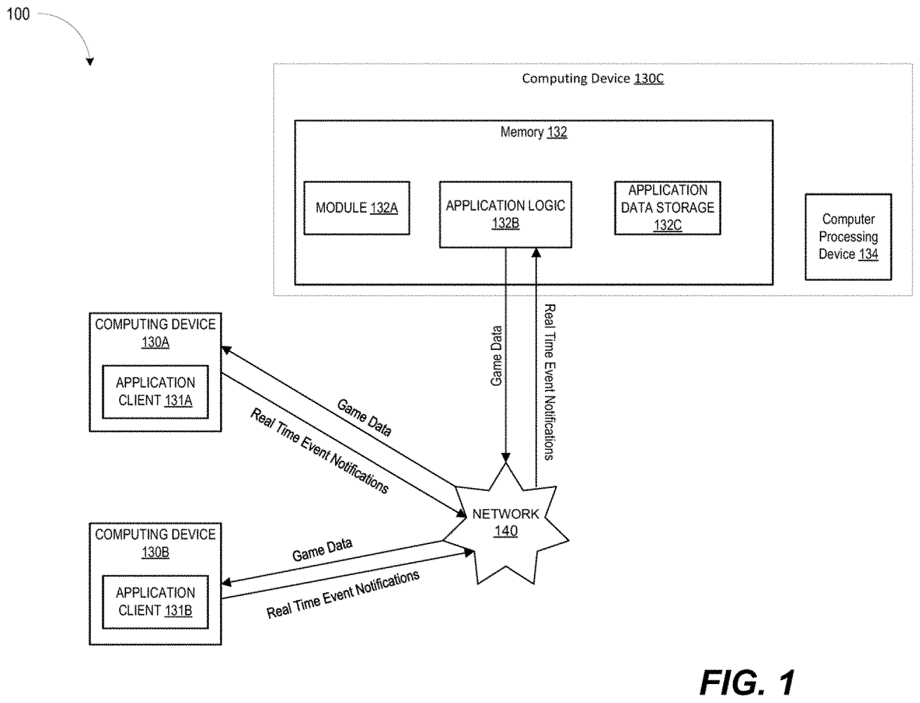

FIG. 1 is a block diagram that illustrates a gameplay network architecture 100 (herein after game architecture 100), in accordance with some embodiments of the present disclosure. As illustrated in FIG. 1, the game architecture 100 may include computing devices 130A-C. Each computing device 130 may include hardware such as processing: devices (e.g., processors, central processing units (CPUs), memory (e.g., random access memory (RAM), storage devices (e.g., hard-disk drive (FWD), solid-state drive (SSD), etc.), and other hardware devices (e.g., sound card, video card, etc.). The computing devices 130 may comprise any suitable type of computing device or machine that has a programmable processor including, for example, server computers, desktop computers, laptop computers, tablet computers, smartphones, set-top boxes, etc. In some examples, each computing device 130 may be a single machine or may include multiple interconnected machines (e.g., multiple computers configured in a cluster). For example, computing device 130A may be a smartphone on which an application client 131 A may execute, while computing device 130C may be a server for hosting and providing access to the application client 131A, such as, for example, a computer game (e.g., online or mobile, multi-player, single-player, etc.).

Although illustrated as having only computing devices 130 for ease of illustration and description, game architecture 100 may include any appropriate number of components (e.g., network devices, computing devices, applications). The computing devices 130 may he coupled to each other e.g., may be operatively coupled, communicatively coupled, may communicate data/messages (e.g., packet capture requests and captured packets) with each other) via network 140. Network 140 may be a public network (e.g., the Internet), a private network (e.g., a local area network (LAN) or wide area network (WAN)), or a combination thereof In one embodiment, network 140 may include a wired and/or a wireless infrastructure, which may be provided by one or more wireless communications systems, such as a WiFi hotspot connected with the network 140 and/or a wireless carrier system that can be implemented using various data processing equipment, communication towers (e.g,, cell towers), etc. The network 140 may also include various components, such as, for example, switches, routers, bridges, gateways, servers, computers, cables, chips integrated circuits, etc. The network 140 may carry communications e.g., data, messages, packets, frames, etc.) between computing devices 130 and any other components of game architecture 100.

Computing device 130C may include computer processing device 134 (hereinafter processing device 134) and memory 132. Memory 132 may include highlight generation module 132A (hereinafter referred to as module 132A), application logic 132B, and application data storage 132C. Application logic 132B may provide the logic for enabling a content providing service (e.g., mobile gaming, streaming video service, etc.) to process and stream or otherwise provide content to a user. For example, application logic 132B may provide logic for streaming video content to subscribers of a video streaming service. In the mobile gaming example of FIG. 1, application logic 132B may provide the fundamental game technology that allows a global network of users (represented, for example, by computing devices 130A and 130B for simplicity) to instantly communicate game actions and events between each other. The application logic 132B can manage notifications of real-time events during game play (e.g., combat between players, assistance from an ally, movement of troops, quest rewards, city statistics, etc.). A player (e.g., computing devices 130A and 130B) may send real-time event (RTE) notifications that are received at computing device 130C where application logic 132B may process and forward the notifications to other players.

The application logic 132B may utilize time-based processing to manage event progression in real-time throughout the game. The application logic 132B may utilize time-based processing to either serialize concurrent activity (e.g., alliances, marches/wars, tile updates, and the like) or of work (e.g., pushing notes, event processing payouts, batch emails, and the like). The application logic 132B (which can fully model the game) can proceed at discreet points occurring at some periodic interval. These points may be referred to as time steps. For example, a game can process a time step every 100 ms or other suitable time period. Although in many cases such a time step can be at a slower rate than the render speed of the game (e.g., 16 ms for a 60 frames per second game), it is not atypical to have game logic proceed at a slower rate than the rendering frame rate.

The computing device 130 may include a suitable application client, such as application client 131A, which may allow a user device (computing device 130A) to receive and view/interact with content provided by a content provider. For example, application client 131A may be a video streaming client which may interface with and receive streaming video content from application logic 132B (which may be, e.g., part of a video streaming provider) via network 140. In the mobile gaming example of FIG. 1, the application client 131A may be a real-time game engine that can allow a player start up games quickly) with a minimal set of assets. The application client 131A can allow additional assets to be downloaded (e.g., from computing device 130C) later in the background as needed. According embodiment, the application client 131A can include those assets that are necessary to initialize (make fully functional) the game as quickly as possible so that the player can begin playing almost immediately. Over time, the remaining assets (map data, game art, riser interface (UI), game logic, and other data) needed to run the game can be downloaded. (or “streamed”) in the background from, for example, computing device 130C. For instance, design data for the virtual environment of the mobile gale can be streamed to and dynamically updated on the application client 131A. In this way, the application logic 132B can allow for rapid, data-driven development of features without the need for a redeployment of the base code that implements the virtual environment.

As a game progresses, the actions transmitted by users to the application logic 132B and the events that occur in the game as a result may be saved by the application logic 132B within application data storage 132C. Application data storage 132C may function to store data/content provided by the application logic 132B. For example, in a streaming video application, application data storage 132C may store movies and television shows (e.g., as m4a files or other suitable file type) which may be accessed by application logic 132B to be streamed to a user who ti ashes to view the content. In the mobile gaming example of FIG. 1, application data storage 132C may store records of games in progress, as well as completed games,as game files that include all the events that occurred during the game on a time step by time step basis. Each game file may fully define every aspect of a game by specifying the full state of the game at each of the time steps that occur between the beginning and end of the game. As discussed herein, the state of the game may include the position (also referred to as spatial characteristics) of the characters and other game elements within the map/environment of the game, events involving certain characters (and the spatial characteristics thereof), a current score of the game a status of all other elements of the game, and the like.

Computing device 130C may use module 132A to deters nine the portions game(s) or any other appropriate viewable content that are of the most interest to one or more users the highlights), and compile those portions into a highlight video for display or presentation to the one or more users. Although discussed in terms of mobile game content, embodiments of the present disclosure described herein may be used to generate a highlight video of (e.g., based on) any appropriate viewable content. (e.g., movies, television shows, music, streaming events, etc.). For example, computing device 130C may be part of a video streaming service provider and may execute module 132A to determine the portions of a streaming movie(s) or television show(s) that are of the most interest to one or more users (i.e., the highlights), and compile those portions into a highlight video for display or presentation to the one or more users. In other examples, computing device 130C may he a platform for live streaming of a sports event and may execute module 132A to determine the portions of an event that are of the most interest to one or more users (i.e., the highlights), and compile those portions into a highlight video for display or presentation to the one or more users.

In some embodiments, computing device 130C may create a highlight video for a video (e.g., movie, TV show episode). In some embodiments, computing device 130C may access and analyze stored video data from a hard drive or similar storage mechanism, while in other embodiments computing device 130C may analyze, live/real-time video (e.g., live television, streaming video). Computing device 130C may utilize active triggers, such as time-based state data (also referred to as video metadata) that the video is annotated with, to guide subdivision of the video into segments of interest. Examples of such time-based state data may include, for example., scene change markers, scene metadata (e.g., music used in the scene, actors in the scene, descriptions of the scene), per-segment computer information, and the like.

In addition to or alternatively, computing device 130C may utilize non-annotated video data to guide subdivision of the video into segments of interest. For example, computing device 130C may utilize suitable video/image processing algorithms to detect events in the video, such as, for example, scene changes (e.g., a momentary black screen or when a current frame is coded as an intra-coded frame), and changes in the content of the video (e.g., based on the difference between a current frame and a previous frame and/or how a current frame is encoded compressed). For example, computing device 130C may define a segment based on scenes or portions of scenes in which there were numerous changes in content, as this may be indicative of a scene of interest (e.g., an action scene or a chase scene). In some embodiments, computing device 130C may separate the video into time steps and the annotated and/or unannotated data from the video may be used to determine an interest score for each time step. Computing device 130C may then define one or more segments using the time steps of the video and each time step's corresponding interest score.

In some embodiments, computing device 130C may create highlights of any suitable non-video content, such as, for example, audio or music (e.g., stored or streaming). For example, computing device 130C may utilize any metadata that the music is annotated with (e.g., artist data, genre data, beats per minute) to subdivide a song(s) or album into segments of interest. Alternatively or in addition to, computing device 130C may use non-annotated data to detect characteristics of the music (e.g., frequency, pitch range, bass level), which can be used to guide subdivision of the song(s) or album into segments of interest.

In some embodiments, computing device 130C may create a highlight video for a game that was previously played, the game data of which is stored in application data storage 132C. For example, a user may wish to view highlights of a game they recently completed and may send a request to computing device 130C indicating the particular game for which they wish to view highlights. Thus, computing device 130C may access the application data storage I 32C and retrieve the game file corresponding to the request. In other embodiments, computing device 130C may create a highlight video for a game that is about to start or is currently in progress. For example, a user may begin a game and simultaneously send a request to the computing device 130C for creation of a highlight video, although the present invention can automatically create the highlight video or videos for each or any game without requiring the user to send such requests. In such cases, computing device 130C may monitor the actions and events of the game on a time step by time step basis through the application logic 132B. However, according to some embodiments, the monitoring, analysis, and subsequent creation of the highlight video may be performed by any of the computing devices 130. For example, either or both computing devices 130A and 130B can comprise processing components and modules similar to computing device 130C to allow computing devices 130A and/or 130B to monitor and analyze content and to create such highlight videos. Alternatively, portions of the monitoring and analysis of content and the creation of the highlight videos can be distributed among and performed by any combination of the computing devices 130A, 130B, and 130C.

Upon executing module 132A, computing device 130C may define a minimum length of a segment of viewable content. The highlight video may be comprised of a set of segments, where each segment may include a portion of game content that is determined to be of interest to a user as discussed in further detail herein. The minimum segment length may be any suitable length of time and may be specified as any suitable period of time (e.g., seconds, minutes, etc.). According to some embodiments, the minimum segment length may be any suitable file size and may be specified as any appropriate file size (e.g., megabytes, gigabytes, etc.). The minimum segment length can be specified, for example, through a user-defined configuration parameter, or be predefined by computing device 130C as an appropriate delimit value (e.g., that can be later changed by the user or system). The minimum segment length specifies the minimum size of a segment (e.g., in terms of units of time and/or size of a corresponding file) and thus prevents the selection of impractically small (e.g., 1 millisecond, 1 kilobyte) segments. In some embodiments, the appropriate minimum segment length may correspond to how small a portion of the game a user could practically view. For example, if the content of a game is being played back at its original speed, a minimum segment length on the order of approximately 1 second may be appropriate. In other examples, the minimum segment length could comprise a single frame (e.g., 16 ms for a 60 frames per second game). In some embodiments, there may be no maximum segment length. Upon determining the minimum segment length, computing device 130C may analyze each of the plurality of time steps that the game is comprised of to determine which time steps include content (e.g., actions/events) that are or may be of interest to the user. For example, computing device 130C may determine an interest score for each time step of the game.

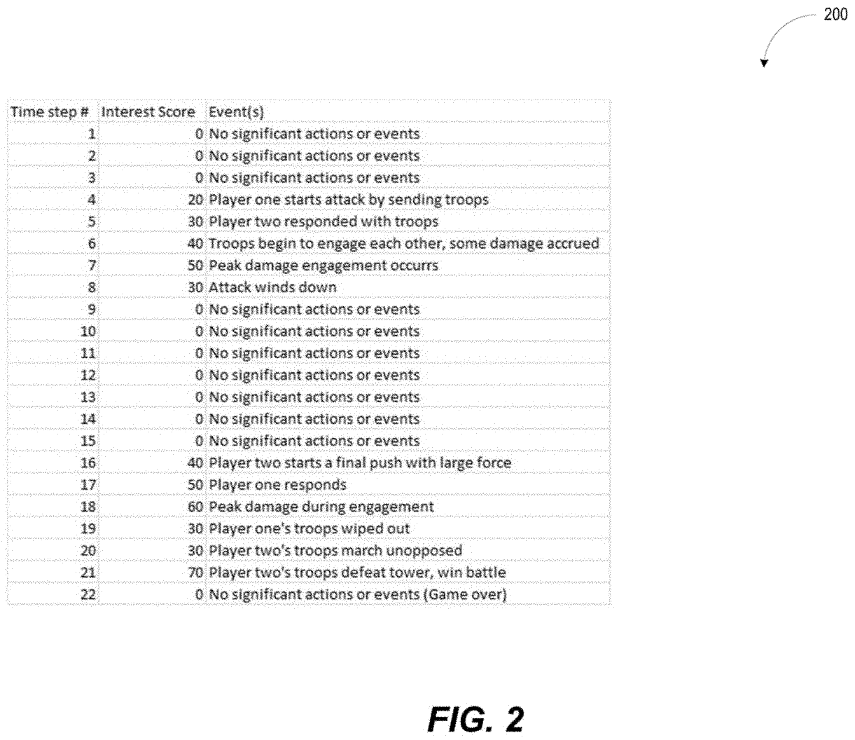

As discussed above, the game may comprise a series of events distributed over a plurality of time steps. For purposes of illustration and not limitation, FIG. 2 illustrates a chart 200 of a progression of a game over a plurality of time steps with respect to game events (hereinafter referred to as events) that occurred at each time step of the game as well as an interest score for each time step. In some embodiments, computing device 130C may assign an interest score to a time step based on the degree to which the events of a time step in the aggregate impacted the game. For example, in a battle game, the amount of damage done during battle may be represented as hit points. Computing device 130C may analyze the events of a time step, determine that two players attacked each other, and determine the number of hit points accrued during the time step to determine the interest score of the time step. For example, the more hit points accrued during a time step, the higher the degree of impact the time step may have had on the game, and subsequently the higher the interest score assigned to the time step. In the present illustration, because the game is a battle game, the most significant events may be those where the most damage is done. In the example of FIG. 2, time step 6 included events where troops of two players begin to engage each other and some damage accrued. Thus, computing device 130C assigned time step 6 an interest score of 40. However, the events of time step 7 included peak damage of the engagement between the troops of those two players (and thus likely had a more significant impact on the game). Consequently, computing device 130C assigned time step 7 an interest score of 50. As discussed in further detail herein, in some embodiments, computing device 130C may analyze the hit points accrued by a certain player in accordance with a user (or system) configuration parameter indicating that damage to the other player is of more interest. Although illustrated and described with respect to hit points/damage accrued, computing device 130C may assign an interest score to a time step based on any suitable and various types of events/content that can occur in the time step, such as, for example, introduction of new troops or a new troop type, joining or elimination of a player, troop movement, and the like in the context of mobile or online computer games. However, the determination and assignment of interest scores will depend on the type of game or other application content.

For example, in a football game, the impact of events in a time step may correspond at least in part to the number of yards gained/lost by a player. Thus, computing device 130C may analyze the events of a time step and determine the number of yards gained lost by a player to determine the interest score. In some embodiments, computing device 130C may bias the interest score based on the intended audience. For example, a player may want to have his/her highlight video of the game show Favorable events (i.e., more favorable to him/her) rather than unfavorable. Consequently, in the present illustration, computing device 130C may bias a 10 yard gain in the player's favor more than a 10 yard loss, and vice versa for the opponent. In some embodiments, events occurring at certain points of the game may have additional weight. For example, an interest score for a time step closer to the beginning or end of a game can be multiplied by an appropriate factor, such that events at the end or beginning of the game can have a greater impact on the interest score.

In still other embodiments, computing device 130C may bias events related to a player-configurable or system-configurable aspect of the game. For example, if a new element (e.g., a new troop) is introduced to the game with a desire to promote it, computing device 130C may bias events involving this new element to have additional weight when contributing to an interest score for the time step in which the event took place.

As illustrated in. FIG. 2, during the first three time steps, there were no significant actions or events, and, thus, computing device 130C may assign an interest score of 0 to time steps 1-3. However, at time step 4, player one started attacking by sending troops, which merits an interest score of 20 for time step 4. At time step 5, player two responded with troops such that the interest score of time step 5 is 30. At time step 6, the troops for each player begin to engage each other, with some damage accruing, and, therefore, an interest score of 50 is assigned to time step 6. At time step 7, the attack begins to wind down, and, thus, the interest score for this time step is 30. At time step 9, there are no significant actions or events, and, therefore, the interest score for time step 9 is 0. Computing device 130C may continue assigning interest scores in the manner described herein until each time step of the game has an interest score assigned. As discussed in further detail herein, each time step may be associated with/assigned to a particular segment (i.e., a time step is associated with one segment and not otherwise shared between two or more segments).

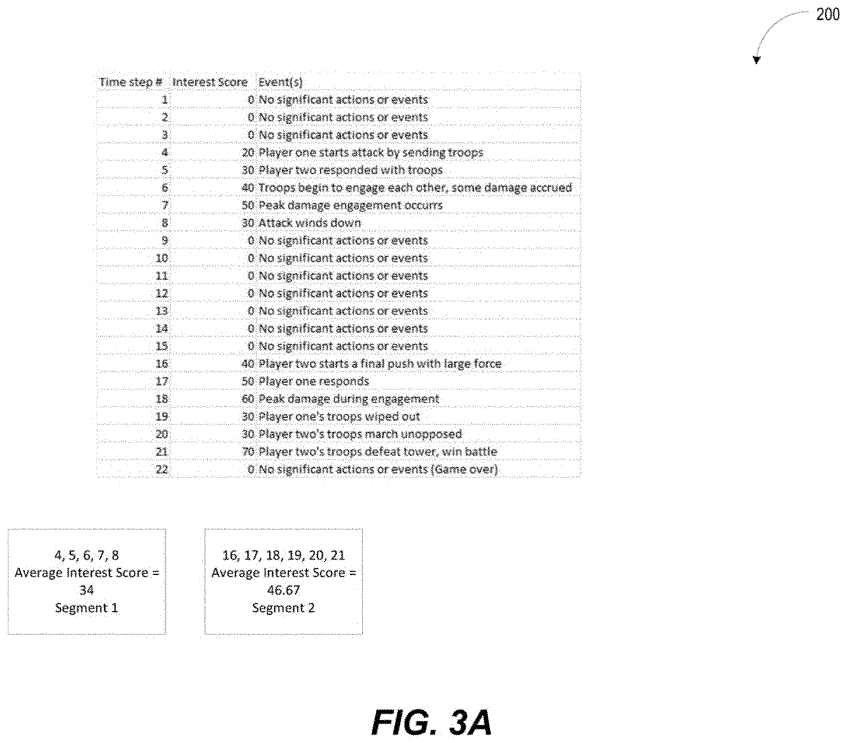

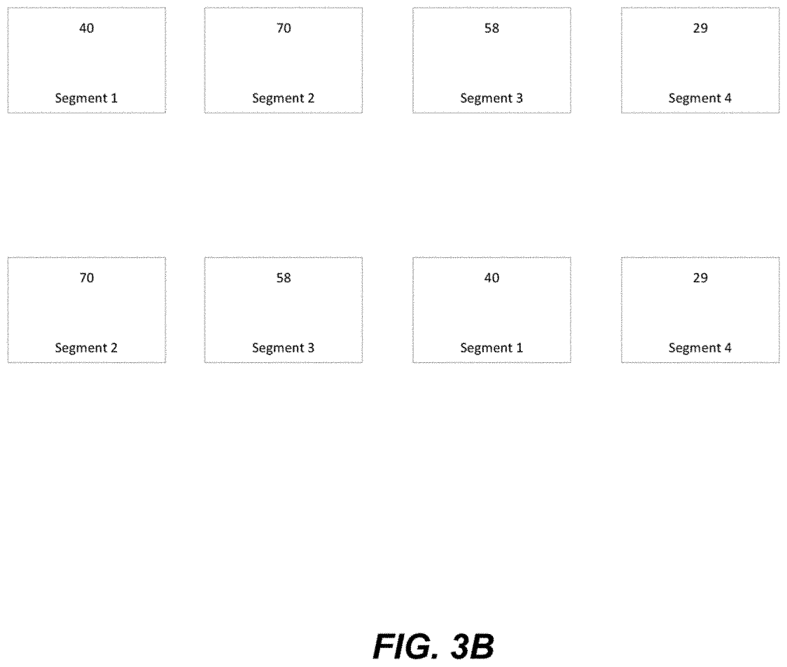

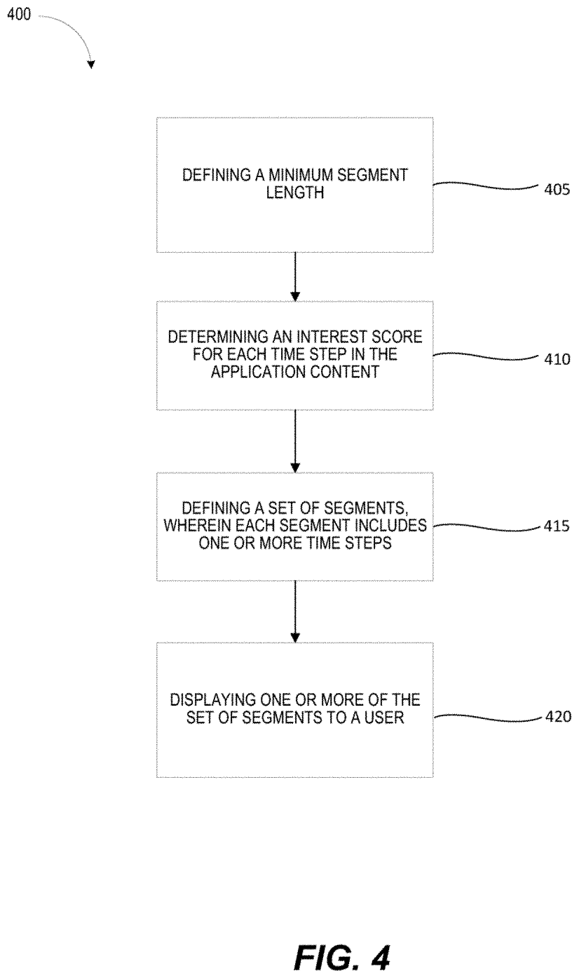

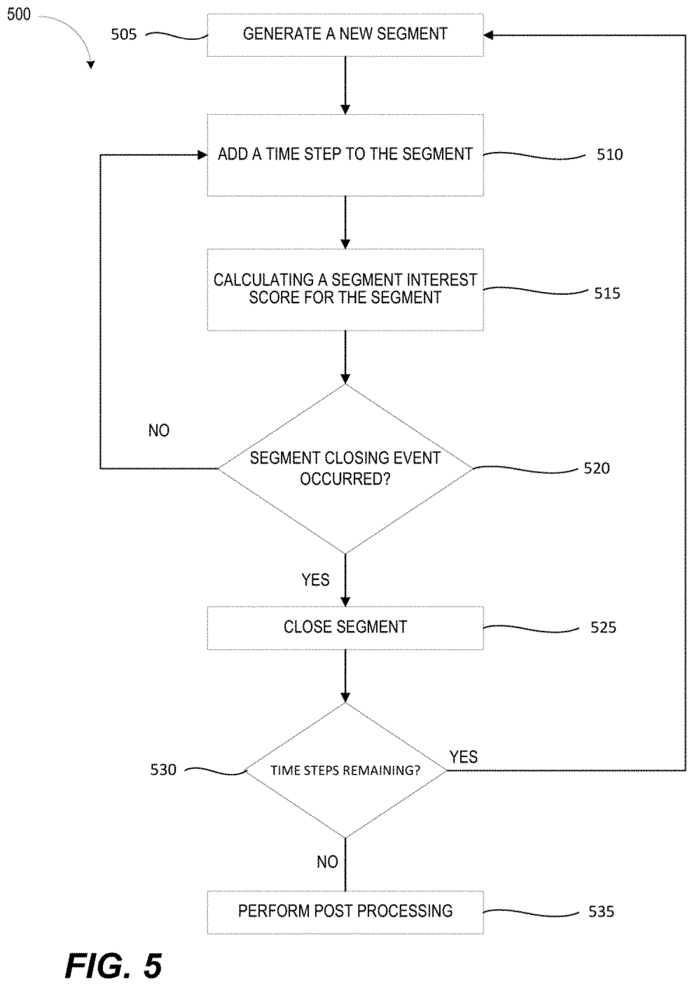

Upon assigning an interest score to each time step of the game, computing device 130C may define a set of segments, where each segment may include one or more time steps corresponding to a portion of the game that is or may be of interest to the user, as discussed in further detail herein. The minimum segment length and other characteristics of each segment may be determined as discussed above. Computing device 130C may add one or more time steps to each segment. Each segment in the set of segments may have a different number of time steps. For purposes of illustration and not limitation, FIG. 3A illustrates Segments 1 and 2 as well as the chart 200 detailing the progression of the game with respect to game events that occurred at each time step of the game. Computing device 130C may generate a first segment “Segment 1” that is blank and uninitialized (e.g., initially includes no time steps). Computing device 130C may begin adding time steps to Segment 1 in a sequential manner. For each time step added, computing device 130C may calculate the segment interest score for Segment 1, which may correspond to the average interest score of time steps in the segment, the absolute (or aggregate) interest score of time steps in the segment, or any other appropriate score metric as discussed in further detail herein. For purposes of illustration and not limitation, in the example of FIG. 3A, the segment interest score for a segment is calculated as the average interest score of time steps in the segment. Computing device 130C may continue to add time steps to Segment 1 until a segment closing event occurs as discussed in further detail herein. For example, computing device 130C may continue to add time steps to Segment 1 until the segment interest score of Segment 1 drops. In other examples, computing device 130C may continue to add time steps to Segment 1 until the segment interest score drops by, to, or below a certain threshold. In this manner, periods of relatively slightly less interesting activity may not result in the premature closure of a segment.

For example, computing device 130C may add time step 1 to the Segment 1, which brings the current segment interest score of Segment 1 to 0. In some embodiments, when initializing (adding a first time step to) a segment, computing device 130C may skip time steps that have an interest score of 0, or an interest score that is below a new segment threshold. As illustrated in FIG. 3A, computing device 130C may skip time steps 1-3, and initialize Segment 1 by adding time step 4 to Segment 1, resulting in the segment interest score of Segment 1 increasing to 20. Computing device 130C may then add time step 5 to Segment 1. Because time step 5 has an interest score of 30, the segment interest score of Segment 1 may increase to an average of 25. Computing device 130C may then add time step 6, which has an interest score of 40, resulting in the segment interest score of Segment 1 increasing again to an average of 30. After adding time step 7, the segment interest score of Segment 1 array increase to an average of 35.

Computing device 30C may then add time step 8, which has an interest score of 30, which results in the segment interest score of Segment 1 dropping by one to an average of 34. In the example of FIG. 3A, the threshold segment score drop may be set to 5 (or any other appropriate value). Therefore, because the drop in the segment interest score (i.e., 1) was within the threshold segment score drop (i.e., less than 5), computing device 130C may determine that time step 8 may be included in Segment 1. Computing device 130C may then add time step 9 to Segment 1, resulting in the segment interest score of Segment 1 dropping to an average of 28.3. Adding time step 9 results in a drop of 5.7 from the previous average interest score, which is more than the threshold segment score drop of 5. Thus, computing device 130C may determine that time step 9 will he excluded from Segment 1 and may close Segment 1 (in this example, a drop in the segment interest score of Segment 1 of more than the threshold segment score drop results in a segment dosing event). Thus, Segment 1 may include time steps 4-8, with the segment interest score comprising an average of 34. In this way, computing device 130C may evaluate each time step to determine whether the segment interest score of the current segment has improved or worsened. In some embodiment, computing device 130C may wait for a threshold number of consecutive time steps that result in a drop (whether less than or equal to or greater than the threshold interest score drop) in the segment interest score of Segment 1 before closing Segment 1. This can be done to ensure that small periods of lower interest (e.g., between periods of higher interest) do not result in prematurely closing a segment.

Continuing the example of FIG. 3A, computing device 130C may close Segment 1 upon analyzing time step 9 as discussed, and may then create a second uninitialized segment “Segment 2.” As discussed above, in sonic embodiments, computing device 130C may not initialize a new segment with a time step having an interest score of 0 or that is below a new segment threshold. Therefore, in the present illustration, computing device 130C may skip time step 10. In this manner, computing device 130C may skip time steps 10-15, since each of these time steps have an interest score of 0. Computing device 130C may add time step 16, having an interest score of 40, thus initializing Segment 2 with time step 16. Computing device 130C may then add time steps 17 and 18, resulting in the segment interest score increasing to an average of 50 (i.e., (40+50+60)/3). Computing device 130C may then add time step 19 to Segment 2, resulting in the segment interest score dropping to an average of 45. In the example of FIG. 3A, computing device 130C may not close Segment 2 if the drop in the segment interest score of Segment 2 is equal to or less than the threshold segment score drop. Because the drop from the previous segment interest score was 5, which is equal to the threshold segment score drop, computing device 130C may not close the segment. Instead, in some embodiments, computing device 130C may wait for a threshold number of consecutive time steps that result in a drop (of less than or equal to the threshold segment score drop) in the segment interest score before closing Segment 2. Because time step 19 is the first time step to result in a segment interest score drop, computing device 130C may then add time step 20, resulting in the segment interest score of Segment 2 dropping to an average of 42. In the example of FIG. 3A, the threshold number of consecutive segment interest score drops may be 3(although any suitable number he used for such a threshold). Thus, computing device 130C may not close Segment 2 (also because the segment score drop was 3, which is less than 5) and may add time step 21, which has an interest score of 70. This results in the segment interest score of Segment 2 increasing to an average of 46.67. Therefore, computing device 130C may determine that time steps 19 and 20 were momentary periods of lower interest and may include time steps 19, 20 and 21 in Segment 2. In some embodiments, computing device 130C may close a segment even if the threshold number of consecutive time steps resulting in a segment score drop has not been reached if a segment interest score drop is significant enough (e.g., is above a second threshold segment score drop).

Computing device 130C may then add the final time step 22, which has an interest score of 0, and results in the segment interest score for Segment 2 of an average of 40. Because the drop (i.e., 6.67) is greater than the segment score drop threshold, computing device 130C may exclude time step 22 and close Segment 2, because there are no more time steps to analyze (e.g., the game is over). Thus, Segment 2 may include time steps 16-21 and may have the segment interest score comprising an average of 46.67. The above method may be repeated until all time steps have been analyzed. Because time step 22 is the last time step in the game data in the current example, computing device 130C may complete the definition of the set of segments alter closing Segment 2.

Although discussed in terms of average segment interest score of time steps in the segment, other suitable ways of calculating a segment interest score, determining whether the segment interest score (and subsequently the interest level) is increasing or decreasing, and determining whether a segment should be closed or not may be utilized. For example, computing device 130C may calculate a segment interest score as the absolute (or aggregate) interest score of all of the time steps included in the segment. The criteria for closing a segment may be referred to as a segment closing event, which may be based on one or more of a threshold segment interest score (that the segment interest score of a segment cannot fall below), a threshold amount by which a segment interest score can fall in response to a time step being added, the rate at which the segment interest score is decreasing (e.g., a “derivative” in mathematical terms), a threshold number of consecutive time steps that result in a drop in the segment interest score, whether the segment interest score per number of included time steps has increased or not, the configuration parameter specifying the minimum segment length, a configuration parameter specifying an appropriate maximum segment length, and the rate at which the segment's interest score is decreasing, among others. For example, if a sufficiently large segment has been built up from time steps (exceeding the minimum segment length defined above), and the next time step worsens (i.e., decreases) the segment's interest score, the segment can be closed and a new segment can be created. Alternatively, if the addition of a time step results in reaching a specified maximum segment length, then computing device 130C may close the segment. As discussed above, a segment interest score may refer to the average interest score of time steps in a segment, absolute (or aggregate) interest score of time steps in a segment, or any other appropriate score metric.

In some embodiments, upon analyzing all time steps and defining a set of segments based thereon, computing device 130C may compare segments and sort them (e.g., from highest segment interest score to lowest segment interest score) or cull them (e.g., to remove lowest scoring segments), for example, to limit the total amount of “highlight video” to those segments with the highest segment interest scores. For example, a maximum time length for a highlight video may be defined (e.g., by a system- or user-specified parameter). Consequently, computing device 130C may sort the segments based on their segment interest score and cull the lowest scoring segments (e.g., one at a time) until a time length of the segments that is within the maximum time length for a highlight video has been reached.

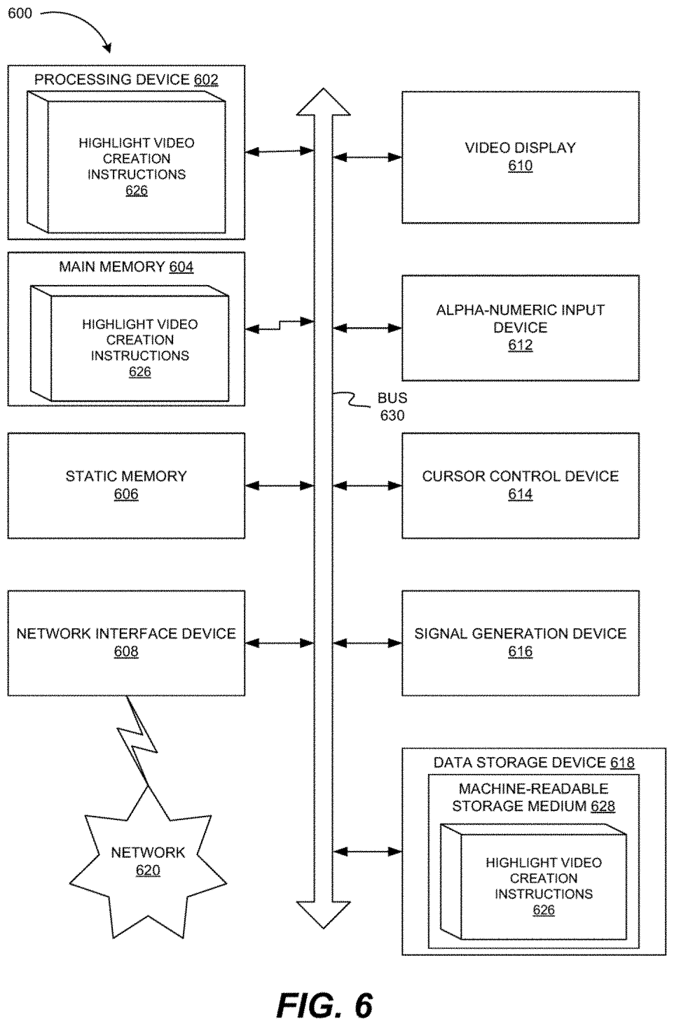

In some embodiments, computing device 130C may change the order of the segments based on each segment's interest score. FIG. 38 illustrates another example of Segments 1 and 2 illustrated in FIG. 3A, with additional Segments 3 and 4 for illustrative purposes. In this example, each segment has one or more time steps assigned to it and thus has a segment interest score as illustrated. Computing device 130C may sort each, segment based on their relative segment interest scores. In the example of FIG. 38, Segments 1-4 have been reordered to Segment 2 (segment interest score of 70), Segment 3 (segment interest score of 58), Segment 1 (segment interest score of 40), and Segment 4 (segment interest score of 29), and computing device 130C may assemble the segments into a highlight video in that order. In some embodiments, computing device 130C may select a middle segment, such as Segment 3 or Segment 1, to display to a user as a “teaser” or preview of the complete highlight video before displaying the complete highlight video to a user.

In some embodiments, the game for which game data is being analyzed may involve moveable camera views. For example, in a football game, the view may be adjustable to view the entire field or zoom into or out of particular locations on the field. In such games, each time step (and, thus, each segment) will include spatial characteristics for the events concurring therein that can be used for camera view configuration. Computing device 130C may compute a spatial bounding subset of where the events of each time step in a segment occurred based on the spatial characteristics of each event. The computing device 130C can then modify the camera view to focus/zoom in on a region of the (virtual) environment corresponding to the spatial bounding subset when displaying the segment as part of a highlight video.

In still other embodiments, upon scoring and sorting each of Segments 1-4, computing device 130C may aggregate the Segments 1-4 with segments from other matches, competitions, events, or content in the game that have been analyzed in a similar manner to generate an aggregate segment list. The computing device 130C can sort the segments in the aggregated segment list by segment interest score as discussed above. Computing device 130C may cull the sorted list in any manner as discussed above (e.g., lowest scores and/or segment/time limit) and generate a multi-player highlight video that shows a user the most interesting content from among a number of matches, competitions, or events played by number of different players. The segments in the multi-player highlight video can also he filtered based on other criteria, such as, for example, date/time of the match (e.g., to limit the highlight video to highlights of a certain day or week), players involved (e.g., to limit the highlight video to highlights of matches played by certain players), and games played or type of game played (e.g., to limit the highlight video to highlights of a particular game(s) or a particular type(s) of game), among others.

FIG. 4 is a flow diagram illustrating a method 400 for determining the portions of application content (e.g., a mobile or online computer game or the like) or any other appropriate viewable content that is or may be of the most interest to a user (i.e., the highlights), and compiling those portions into a highlight video for display or presentation to one or more users, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof In some embodiments, the method 400 may be performed by a computing device (e.g., computing device 130C illustrated in FIG. 1 or any of the computing devices 130).

In some embodiments, computing device 130C may create a highlight video for application content with which a user previously interacted or is currently interacting, the data of which can be stored in a suitable memory or data storage (e.g., application data storage 132C). For example, a user may wish to view highlights of an event or events in application content they recently completed, and may send a request to computing device 130C indicating the particular application content for which they wish to view highlights. Thus, computing device 130C may access the application data storage and retrieve the data file corresponding to the request. In other embodiments, computing device 130C may create a highlight video for application content that is about to start, or is currently in progress. For example, a user may begin application content and simultaneously send a request to the computing device 130C for creation of a highlight video. Either in response to such requests or automatically, computing device 130C may monitor the actions and events of the application content on a time step by time step basis through the application logic 132B.

Upon executing module 132A, at block 405 computing device 130C may define a minimum length of a segment of viewable content. The highlight video may be comprised of a set of segments, where each segment may include a portion of application content that is determined to be of interest to a user as discussed in further detail herein. Upon determining the minimum segment length, computing device 130C may analyze each of the plurality of time steps that the application content is comprised of to determine which time steps include content (e.g., actions/events) that are of interest to the user. At block 410, computing device 130C may determine an interest score for each time step of the application content,

Upon assigning an interest score to each time step of the application content, at block 415, computing device 130C may define a set of segments, where each segment may include one or more time steps corresponding to a portion of the application content that is or may he of interest to the user, as discussed in further detail herein. The minimum segment length and other characteristics of each segment may be determined as discussed above. Computing device 130C may add one or more time steps to each segment. Each segment m the set of segments may have a different number of time steps. For example, FIG. 3A illustrates Segments 1 and 2 as well as the chart 200 detailing the progression of a mobile or online computer game with respect to game events that occurred at each time step of the game. As discussed in further detail herein, each time step may be associated with/assigned to a particular segment (i.e., a time step is associated with one segment and not otherwise shared between two or more segments).

FIG. 5 is a flow diagram illustrating a method 500 for defining one or more segments, in accordance with some embodiments of the present disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running executing on a processing device), firmware (e.g., microcode), or a combination thereof. In some embodiments, the method 500 may be performed by a computing device (e.g., computing device 130C illustrated in FIG. 1 or any of the computing devices 130).

With reference to FIG. 3A as well, at block 505, computing device 130C may generate a new segment (e.g., Segment 1 of FIG, 3A) that is blank and uninitialized (e.g., initially includes no time steps). At block 510, computing device 130C may begin adding time steps to the segment in a sequential manner. For each time step added, computing device 130C may calculate the segment interest score of the segment, which may be based on the average interest score of time steps in the segment, the absolute aggregate) interest score of time steps in the segment, or any other suitable scoring metric as discussed in further detail herein. For example, the segment interest score may be calculated as the average interest score of time steps in the segment. Computing device 130C may continue to add time steps to the segment until a segment closing event occurs. For example, computing device 130C may continue to add time steps to the segment until the segment interest score of the segment drops. In other examples, computing device 130C may continue to add time steps to the segment until the segment interest score drops by a threshold amount or experiences a threshold number of consecutive drops. In this manner, relatively small periods of less interesting activity do not result in the premature closure of a segment.

In some embodiments, when initializing (adding a first time step to) a segment, computing device 130C may skip time steps that have an interest score of 0, or an interest score that is below a new segment threshold. At block 515, the computing device 130C may calculate the segment interest score (e.g., by calculating the average segment interest score). At block 520, computing device 130C may determine whether a segment closing event has occurred. If no segment closing event has occurred, method 500 may proceed to block 510 where computing device 130C may then add another time step to the segment. At block 515, computing device 130C may again calculate the segment interest score of the segment (e.g., by calculating the average segment interest score). At block 520, computing device 130C may determine that no segment closing event has occurred and again proceed to block 510, where computing device 130C may then add another time step, and then proceed to block 515, where computing device 130C may again calculate the segment interest score. Method 500 may proceed in this manner until at block 520 computing device 130C determines that a segment closing has occurred.

For example, at block 520, if computing device 130C calculates that a drop in the current segment interest score from the previous segment interest score is more than a threshold amount, computing device 130C may determine that a segment closing event has occurred (i.e., drop in the segment interest score of the segment is beyond a threshold segment score drop). Thus, computing device 130C may exclude the current time step from the segment, and at block 525 may close the segment. In this way, computing device 130C may evaluate the impact of each time step added to the current segment to determine whether the segment interest score of a current segment has improved or worsened. In some embodiments, computing device 130C may wait for a threshold number of consecutive time steps that result in a drop (whether less than or equal to or greater than the threshold interest score drop) in the segment interest score of the segment closing that segment. This can be done to ensure that small periods of lower interest (e.g., between periods of higher interest) do not result in prematurely closing a segment.

At block 530, computing device 130C may determine whether there are any time steps of the application client remaining. If time steps still remain, the method 500 proceeds to block 505 where computing device 130C generates a second segment (e.g., Segment 2 of FIG. 3A). As discussed, in some embodiments, computing device 130C may not initialize a new segment with a time step having an interest score of 0 or that is below a new segment threshold. At block 510, computing device 130C may add a (non-zero) time step. At block 515, computing device 130C may calculate the segment interest score of the second segment. At block 520, computing, device 130C may determine that no segment closing event has occurred and proceed to block 510 to add an additional time step. At block 515, computing device 130C may calculate the segment interest score of the second segment. According to some embodiments, computing device 130C may not close the second segment if the drop in the segment interest score of the second segment is equal to or less than a threshold interest score drop. Instead, computing device 130C may wait for a threshold number of consecutive time steps that result in a drop (of less than or equal to the threshold) in the segment interest score before closing the second segment. In some embodiments, computing device 130C may close a segment even if the threshold number of consecutive time steps resulting in segment interest score drops has not been reached if a drop is significant enough (e.g., is above a second threshold segment score drop).

If a segment closing event has not occurred, then the method 500 may proceed back to block 510 where computing device 130C may then add another time step to the second segment. At block 515, the segment interest score for the second segment is calculated. If the new segment interest score results in a drop from the previously calculated segment interest score that is greater than the segment score drop threshold, then at block 520 computing device 130C may determine that a segment closing event has occurred, and computing device 130C may exclude the current time step. Consequently, at block 525 the computing device 130C may close the second segment. At block 530, computing device 130C may determine that there are no time steps remaining and cease the method 500. In some embodiments, at block 535, the method 500 may perform suitable post processing to generate and distribute the highlight video.

FIG. 6 illustrates a diagrammatic representation of a machine in the example from of a computer system 600 within which comprises a set of instructions for causing the machine to perform any one or more of the methodologies discussed herein for determining the portions of an application client(s) or any other appropriate viewable content that are of the most interest to a user (i.e., the highlights), and compiling those portions into a highlight video for display or presentation to one or more users, in accordance with some embodiments of the present disclosure. The machine may define a minimum segment length for representing content comprising a plurality of time steps and define an interest score for each of the plurality of time steps. The machine may define a set of segments, each segment in the set including one or more time steps from the plurality of time steps and display or otherwise present one or more of the segments to a user as a highlight video.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequentially or otherwise) that specify actions to be taken by that machine. Further, while only a single machine is illustrated, the term “machine” shall also be taken to include any collection of machines that individually or jointly execute a set (or multiple sets) of instructions to perform any one more of the methodologies discussed herein. In one embodiment, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 600 may further include a network interface device 608, which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be a complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices, such as, for example, an application specific integrated circuit (ASIC), a field programmable gate array (FPGA), a digital signal processor (DSP), network processor, or the like. The processing device 602 is configured to execute highlight video creation instructions 626 for performing the operations and steps discussed herein.

The data storage device 618 may include a machine-readable storage medium 628, on which is stored one or more sets of highlight video creation instructions 626 (e.g., software) embodying any one or more of the methodologies of functions described herein, including instructions to cause the processing device 602 to perform the functions described herein. The highlight video creation instructions 626 may also reside, completely or at least partially, within the main memory 604 or within the processing device 602 during execution thereof by the computer system 600; the main memory 604 and the processing device 602 also constituting machine-readable storage media. The highlight video creation instructions 626 may further be transmitted or received over a network 620 via the network interface device 608.

The machine-readable storage medium 628 may also be used to store instructions to perform a method for generating highlight videos, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing: device, a computer, a system on a chip, or multiple ones, or combinations, of the foregoing. A computer processing device may include one or more processors which can include special purpose logic circuitry, e.g., an FPGA (field programmable gate array ASIC (application-specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of then The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single the dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network,

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory, devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry,

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some eases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term“an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

1. A method comprising:
defining a minimum length of a segment for presenting a portion of content from an application client, the content comprising a plurality of time steps;
determining an interest score for each of the plurality of time steps;
defining, by a computer processing device, a set of segments based at least in part on the interest score for each of the plurality of time steps, each segment in the set including one or more time steps from the plurality of time steps; and
providing one or more of the set of segments to a user.

2. The method of claim 1, wherein defining a set of segments comprises:
iteratively, until a segment closing event occurs:
adding a time step from the plurality of time steps to the segment;
calculating a segment interest score of the segment based on an interest score of each time step in the segment; and
determining whether a segment closing event has occurred based, at least in part, on the segment interest score.

3. The method of claim 2, wherein the segment closing event is based on at least one of: a threshold amount by which the segment interest score can fall in response to a time step being added, a threshold segment interest score that the segment interest score cannot fall below, a maximum rate at which the segment interest score can fall, a user parameter specifying a maximum segment length, a user parameter specifying a minimum segment length, or a maximum number of consecutive time steps that result in a drop in the segment interest score.

4. The method of claim 1, wherein determining an interest score for each of the plurality of time steps comprises:
determining an impact of each event that occurred in the time step; and
determining the interest score for the time step based on an aggregate impact of events that occurred in the time step.

5. The method of claim 2, further comprising:
sorting the set of segments based on the segment interest score of each segment, wherein the one or more of the set of segments correspond to segments having highest segment interest scores of the set of segments.

6. The method of claim 1, wherein the application client comprises a mobile computer game.

7. The method of claim 2, wherein the segment interest score corresponds to an average interest score among time steps in the segment.

8. A system comprising:
a memory to store content comprising a plurality of time steps; and
a computer processing device to:
define a minimum length of a segment for presenting a portion of the content from an application client;
determine an interest score for each of the plurality of time steps;
define a set of segments based at least in part on the interest score for each of the plurality of time steps, each segment in the set including one or more time steps from the plurality of time steps; and
provide one or more of the set of segments to a user.

9. The system of claim 8, wherein to define a set of segments, the computer processing device is to:
iteratively, until a segment closing event occurs:
add a time step from the plurality of time steps to the segment;
calculate a segment interest score of the segment based on an interest score of each time step in the segment; and
determine whether a segment closing event has occurred based, at least in part, on the segment interest score.

10. The system of claim 9, wherein the segment closing event is based on at least one of: a threshold amount by which the segment interest score can fall in response to a time step being added, a threshold segment interest score that the segment interest score cannot fall below, a maximum rate at which the segment interest score can fall, a user parameter specifying a maximum segment length, a user parameter specifying a minimum segment length, or a maximum number of consecutive time steps that result in a drop in the segment interest score.

11. The system of claim 8, wherein to determine an interest score for each of the plurality of time steps, the computer processing device is to:
determine an impact of each event that occurred in the time step; and
determine the interest score for the time step based on an aggregate impact of events that occurred in the time step.

12. The system of claim 9, wherein the computer processing device is further to:
sort the set of segments based on the segment interest score of each segment, wherein the one or more of the set of segments correspond to segments having highest segment interest scores of the set of segments.

13. The system of claim 8, wherein the application client comprises a mobile computer game.

14. The system of claim 9, wherein the segment interest score corresponds to an average interest score among time steps in the segment.

15. A non-transitory computer readable storage medium storing instructions, which when executed, cause a computer processing device to:
define a minimum length of a segment for presenting a portion of content from an application client, the content comprising a plurality of time steps;
determine an interest score for each of the plurality of time steps;
define, by the computer processing device, a set of segments based at least in part on the interest score for each of the plurality of time steps, each segment in the set including one or more time steps from the plurality of time steps; and
provide one or more of the set of segments to a user.

16. The non-transitory computer readable storage medium of claim 15, wherein to define a segment, the computer processing device is to:
iteratively, until a segment closing event occurs:
add a time step from the plurality of time steps to the segment;
calculate a segment interest score of the segment based on an interest score of each time step in the segment; and
determine whether a segment closing event has occurred based, at least in part, on the segment interest score.

17. The non-transitory computer readable storage medium of claim 16, wherein the segment closing event is based on at least one of: a threshold amount by which the segment interest score can fall in response to a time step being added, a threshold segment interest score that the segment interest score cannot fall below, a maximum rate at which the segment interest score can fall, a user parameter specifying a maximum segment length, a user parameter specifying a minimum segment length, or a maximum number of consecutive time steps that result in a drop in the segment interest score.

18. The non-transitory computer readable storage medium of claim 15, wherein to determine an interest score for each of the plurality of time steps, the computer processing device is to:
determine an impact of each event that occurred in the time step; and
determine the interest score for the time step based on an aggregate impact of events that occurred in the time step.

19. The non-transitory computer readable storage medium of claim 16, wherein the computer processing device is further to:
sort the set of segments based on the segment interest score of each segment, wherein the one or more of the set of segments correspond to segments having the one or more highest segment interest scores of the set of segments.

20. The non-transitory computer readable storage medium of claim 15, wherein the application client comprises a mobile computer game.
